(19) United States
(12) Patent Application Publication
(10) Pub. No.: US 2026/0237013 A1
(43) Pub. Date: Aug. 13, 2026

(54) SYSTEMS AND METHODS FOR URBAN HEAT ISLAND EFFECT EMERGENCY MONITORING BASED ON INTERNET OF THINGS (IOT) LARGE MODELS

(71) Applicant: CHENGDU QINCHUAN IOT TECHNOLOGY CO., LTD., Chengdu, Sichuan (CN)

(72) Inventors: Hanshu SHAO, Chengdu (CN); Junyan ZHOU, Chengdu (CN); Hongjian LIU, Chengdu (CN); Xing SHU, Chengdu (CN)

(73) Assignee: CHENGDU QINCHUAN IOT TECHNOLOGY CO., LTD., Chengdu, Sichuan (CN)

(21) Appl. No.: 19/638,189

(22) Filed: Apr. 3, 2026

(30) Foreign Application Priority Data
Mar. 10, 2026 (CN) 202610286586.5

(51) Int. Cl. G06Q 50/26; G01W 1/02; G06Q 10/0631; G08G 1/00; G08G 1/0967; G08G 1/0969; G16Y 20/10; G16Y 40/10

(52) U.S. Cl. CPC G06Q 50/265; G01W 1/02; G06Q 10/06312; G08G 1/096725; G08G 1/0969; G08G 1/202; G16Y 20/10; G16Y 40/10; G01W 2203/00

(57) ABSTRACT

Disclosed is a system for urban heat island effect emergency monitoring based on an IoT large model. The system includes an emergency supervision management platform. The emergency supervision management platform is configured to: determine heat island levels of a plurality of candidate nodes; determine one or more target nodes and cooling parameters of one or more target nodes; determine one or more watering vehicles corresponding to the one or more target nodes; send the one or more target nodes to navigation terminals of the one or more watering vehicles corresponding to the one or more target nodes via a wireless network to control the navigation terminals to display navigation routes to the one or more target nodes; and control the one or more watering vehicles and spray systems to perform watering and spraying based on the cooling parameters of the one or more target nodes.

### CROSS-REFERENCE TO RELATED APPLICATIONS

This application claims priority to Chinese Application No. 202610286586.5, filed on Mar. 10, 2026, the entire contents of which are incorporated herein by reference.

### TECHNICAL FIELD

The present disclosure relates to the field of heat island effect monitoring, and in particular to a system and method for urban heat island effect emergency monitoring based on an Internet of Things (IoT) large model.

### BACKGROUND

With the continuous acceleration of climate change and urbanization, the urban heat island effect is becoming increasingly prominent and has become an important factor affecting the environmental quality of cities and the health of residents. The urban heat island effect refers to a phenomenon where urban areas have a significantly higher air temperature than that in the surrounding suburban areas due to frequent human activities, changes in surface coverage, or the like. Traditional urban meteorological monitoring mainly relies on a limited number of ground meteorological stations. The coverage of the ground meteorological stations is limited, making it difficult to comprehensively and meticulously reflect complex thermal environment changes within the city. The limitation constrains accurate identification of high-temperature risks and effective implementation of response measures.

Therefore, it is desirable to provide a system and method for urban heat island effect emergency monitoring based on an Internet of Things (IoT) large model to improve the response capability to the heat island effect and the intelligence level of public services.

### SUMMARY

One or more embodiments of the present disclosure provide a system for urban heat island effect emergency monitoring based on an Internet of Things (IoT) large model. The system includes an emergency supervision management platform. The emergency supervision management platform is configured to execute a method for urban heat island effect emergency monitoring based on an Internet of Things (IoT) large model.

One or more embodiments of the present disclosure provide a method for urban heat island effect emergency monitoring based on an Internet of Things (IoT) large model. The method includes: determining heat island levels of a plurality of candidate nodes based on remote sensing data, meteorological station data, environmental data, and urban activity data; determining one or more target nodes and cooling parameters of the one or more target nodes based on the heat island levels of the plurality of candidate nodes and a preset threshold, each cooling parameter including a watering parameter of a watering vehicles and a spraying parameter of a spray system; determining one or more watering vehicles corresponding to the one or more target nodes based on heat island levels of the one or more target nodes; sending the one or more target nodes to navigation terminals of the one or more watering vehicles corresponding to the one or more target nodes via a wireless network to control the navigation terminals to display navigation routes to the one or more target nodes; and controlling the one or more watering vehicles corresponding to the one or more target nodes and spray systems to perform watering and spraying based on the cooling parameters of the one or more target nodes.

One or more embodiments of the present disclosure provide a non-transitory computer-readable storage medium, comprising computer instructions that, when read by a computer, direct the computer to execute a method for urban heat island effect emergency monitoring based on an Internet of Things (IoT) large model.

### BRIEF DESCRIPTION OF THE DRAWINGS

The present disclosure is further described in a way of exemplary embodiments. The exemplary embodiments are described in detail with reference to the accompanying drawings. The embodiments are non-limiting. In the embodiments, the same reference numerals denote the same structures, wherein:

FIG. 1 is a schematic diagram illustrating a platform structure of a system for urban heat island effect emergency monitoring based on an Internet of Things (IoT) large model according to some embodiments of the present disclosure;

FIG. 2 is a flowchart illustrating an exemplary method for urban heat island effect emergency monitoring according to some embodiments of the present disclosure;

FIG. 3 is a schematic diagram illustrating a structure of a prediction model according to some embodiments of the present disclosure; and

FIG. 4 is a flowchart illustrating an exemplary process of determining a target cooling strategy according to some embodiments of the present disclosure.

### DETAILED DESCRIPTION

To more clearly illustrate the technical solutions in the embodiments of the present disclosure, the following briefly introduces the accompanying drawings required for describing the embodiments. Obviously, the accompanying drawings in the following description are merely some examples or embodiments of the present disclosure. For a person of ordinary skill in the art, without creative efforts, the present disclosure may be applied to other similar scenarios according to these accompanying drawings. Unless obviously obtained from the context or the context illustrates otherwise, the same numeral in the drawings refers to the same structure or operation.

It should be understood that the terms “system”, “device”, “unit”, and/or “module” used herein are a method for distinguishing different components, elements, parts, sections, or assemblies at different levels. However, if other words can achieve the same purpose, the words may be replaced by other expressions.

As shown in the present disclosure and the claims, unless the context clearly indicates an exception, the words “a”, “an”, “one”, and/or “the” are not specifically limited to a singular form and may also include a plural form. Generally, the terms “comprising” and “including” only suggest including steps and elements that have been explicitly identified, and these steps and elements do not constitute an exclusive list. The method or device may also include other steps or elements.

The present disclosure uses flowcharts to illustrate operations performed by the system according to embodiments of the present disclosure. It should be understood that preceding or following operations are not necessarily performed precisely in sequence. Conversely, each step may be processed in reverse order or simultaneously. At the same time, other operations may be added to these processes, or one or more operations may be removed from these processes.

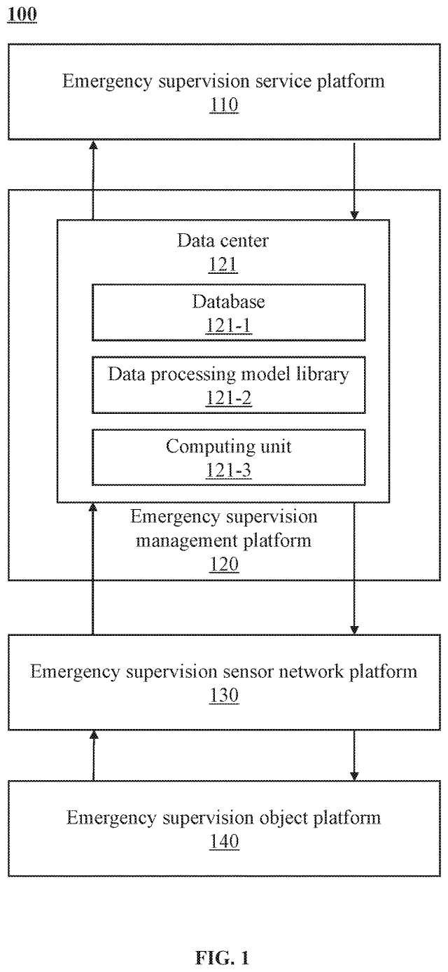

FIG. 1 is a schematic diagram illustrating a platform structure of a system for urban heat island effect emergency monitoring based on an Internet of Things (IoT) large model according to some embodiments of the present disclosure.

In some embodiments, as shown in FIG. 1, the system for urban heat island effect emergency monitoring based on the IoT large model (hereinafter referred to as a system 100) may include an emergency supervision service platform 110, an emergency supervision management platform 120, an emergency supervision sensor network platform 130, and an emergency supervision object platform 140. In some embodiments, the emergency supervision service platform 110, the emergency supervision management platform 120, the emergency supervision sensor network platform 130, and the emergency supervision object platform 140 may be connected to each other in sequence. The IoT large model refers to an IoT model architecture for implementing efficient operation of a large amount of data in the system 100. In some embodiments, an artificial intelligence (AI) model (e.g., ChatGPT, Gemini, and Deepseek) may be applied to the IoT model architecture for sensing and processing data.

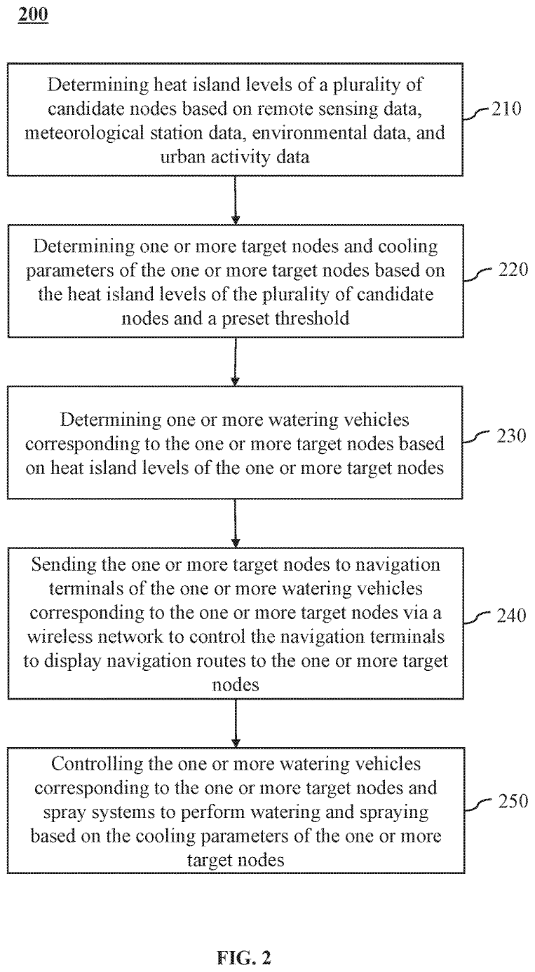

The emergency supervision service platform 110 refers to a platform that provides emergency supervision services, such as an emergency monitoring service for an urban heat island effect. In some embodiments, the emergency supervision service platform 110 is configured as a server, a processor, etc. The emergency supervision service platform 110 may interact bidirectionally with a data center 121 of the emergency supervision management platform 120. In some embodiments, the emergency supervision management platform 120 may obtain urban activity data from the emergency supervision service platform 110 and store the obtained urban activity data in a database 121-1. More descriptions regarding the urban activity data may be found in FIG. 2 and the related descriptions thereof.

The emergency supervision management platform 120 refers to a comprehensive management platform that coordinates and manages connections and collaborations among a plurality of platforms. In some embodiments, the emergency supervision management platform 120 may be a platform for supervising and managing information related to the urban heat island effect. In some embodiments, the emergency supervision management platform 120 may include a server, a processor, a data storage system, a large-screen display system, IoT platform software, a communication component (e.g., a communication interface, a gateway), etc. In some embodiments, the emergency supervision management platform 120 may be a software platform running on a server or in a cloud. The emergency supervision management platform 120 is configured to process data and/or information obtained from other platforms (e.g., the emergency supervision service platform 110 and the emergency supervision sensor network platform 130). The emergency supervision management platform 120 may execute program instructions based on obtained data, information, and/or corresponding processing results to perform functions and/or steps described in the present disclosure.

In some embodiments, the emergency supervision management platform 120 may include the data center 121. The data center 121 may include the database 121-1, a data processing model library 121-2, and a computing unit 121-3.

The database 121-1 is configured to collect, store, and manage data related to the urban heat island effect. For example, the data may be remote sensing data, meteorological station data, environmental data, urban activity data, cooling parameters, an urban heat effect map, initial cooling strategies, candidate cooling strategies, a target cooling strategy, etc. The database 121-1 may include MySQL, PostgreSQL, InfluxDB, Prometheus, etc. More descriptions regarding the remote sensing data, the meteorological station data, the environmental data, the urban activity data, the cooling parameters, the urban heat effect map, the initial cooling strategies, the candidate cooling strategies, and the target cooling strategy may be found in FIGS. 2-4 and the related descriptions thereof.

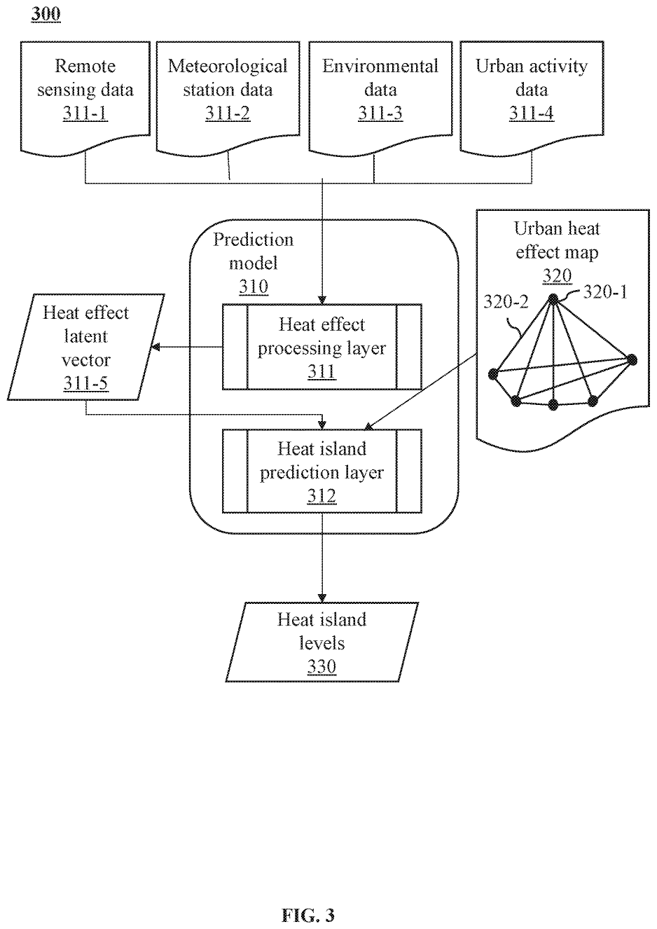

The data processing model library 121-2 is configured to store a trained data processing large model. In some embodiments, the data processing model library 121-2 may include a chatbot, a prediction model, etc. More descriptions regarding the prediction model may be found in FIG. 3 and the related descriptions thereof.

The computing unit 121-3 refers to a functional module that performs arithmetic, logical, and other instruction operations. The computing unit 121-3 may include a processor. The processor may include a central processing unit (CPU), a graphics processing unit (GPU), a field-programmable gate array (FPGA), an application specific integrated circuit (ASIC), an application specific instruction set processor (ASIP), etc.

The emergency supervision sensor network platform 130 refers to a platform for comprehensively managing sensor information. In some embodiments, the emergency supervision sensor network platform 130 may be configured as a communication network and/or a gateway, or the like. The emergency supervision sensor network platform 130 may interact bidirectionally with the data center 121 and the emergency supervision object platform 140. In some embodiments, the emergency supervision sensor network platform 130 may collect the remote sensing data, the meteorological station data, the environmental data, and the urban activity data, and send the remote sensing data, the meteorological station data, the environmental data, and the urban activity data to the emergency supervision management platform 120. The emergency supervision management platform 120 may store the received remote sensing data, meteorological station data, environmental data, and urban activity data in the database 121-1. More descriptions regarding the remote sensing data, the meteorological station data, the environmental data, and the urban activity data may be found in FIG. 2 and the related descriptions thereof.

The emergency supervision object platform 140 refers to a platform of a supervised entity or system and is configured to display, manage, and analyze an operation status and data of the supervised entity or system. In some embodiments, the emergency supervision object platform 140 may include a processor, a server, a gateway, or the like. In some embodiments, the emergency supervision object platform 140 may be configured to manage and control one or more watering vehicles and a spray system. For example, the emergency supervision object platform 140 may establish a communication connection with the one or more watering vehicles and the spray system to achieve bidirectional data interaction. The emergency supervision object platform 140 may receive an instruction from the emergency supervision management platform 120 via the emergency supervision sensor network platform 130, and control the one or more watering vehicles and the spray system to perform a cooling operation.

In embodiments of the present disclosure, the system 100 can automatically and intelligently implement emergency monitoring of the urban heat island effect. Through early identification of the urban heat island effect and precise deployment and guidance of the watering vehicles and the spray system, the cooling efficiency is significantly improved, and the cooling effect is optimized. Meanwhile, use of the IoT large model makes data fusion, analysis, and decision making more efficient and comprehensive.

It should be noted that the above descriptions of the system 100 and the platforms are merely for convenience of description and cannot limit the present disclosure to the scope of the embodiments described. It can be understood that for those skilled in the art, after understanding the principle of the system, various modules may be arbitrarily combined or constitute subsystems to connect with other platforms without departing from the principle.

FIG. 2 is a flowchart illustrating an exemplary method for urban heat island effect emergency monitoring according to some embodiments of the present disclosure. As shown in FIG. 2, a process 200 includes the following operations. In some embodiments, the process 200 may be executed by an emergency supervision management platform.

In 210, determining heat island levels of a plurality of candidate nodes based on remote sensing data, meteorological station data, environmental data, and urban activity data. In some embodiments, the emergency supervision management platform may obtain the remote sensing data, the meteorological station data, the environmental data, and the urban activity data from a database.

The remote sensing data refers to information data about the earth's surface and environment obtained through a remote sensing technology. In some embodiments, the remote sensing data may include a surface temperature, a vegetation coverage rate, or the like. For example, the emergency supervision management platform may analyze the distribution of urban buildings, roads, and green spaces through WorldView satellite images and Shapefile vector data. As another example, the emergency supervision management platform may evaluate surface temperature differences in different regions and locate heat island regions through nighttime thermal infrared images.

The meteorological station data refers to real-time or historical observation information reflecting weather phenomena, climate changes, and atmospheric environmental conditions collected by a meteorological observation station (e.g., a ground station, a sounding station, an automatic weather station, or the like). In some embodiments, the meteorological station data may include an air temperature (e.g., real-time ambient air temperatures in different regions), a wind speed, and a wind direction.

The environmental data refers to real-time or historical information of an environmental state collected by IoT environmental sensors, integrated sensors of smart light poles, or the like. The IoT environmental sensors may be deployed at a location or a node such as a street, a park, a building cluster, or the like. In some embodiments, the environmental data may include a local surface temperature and a local air temperature. For example, the environmental data may be a surface temperature and an air temperature at a location or a node such as the street, the park, a building cluster, or the like.

The urban activity data refers to real-time or historical information of urban activities collected by an urban traffic management system (e.g., a smart traffic signal light and a roadside radar) and an energy consumption monitoring system of a power company. In some embodiments, the urban activity data may include a traffic flow, a vehicle congestion index, building energy consumption data, or the like. The vehicle congestion index refers to a quantitative index comprehensively reflecting a road congestion condition. The vehicle congestion index is usually represented by a value within a range of 0 to 10. A higher value indicates more severe congestion. The building energy consumption data refers to electricity consumption data of a building.

In some embodiments, the emergency supervision management platform may align the remote sensing data, the meteorological station data, the environmental data, and the urban activity data in time and space through a spatiotemporal interpolation model (e.g., spatiotemporal kriging (STK) and a Bayesian spatiotemporal model), data assimilation (e.g., four-dimensional variational assimilation and ensemble Kalman filter), or the like. The emergency supervision management platform may standardize or normalize the aligned remote sensing data, meteorological station data, environmental data, and urban activity data through Z-score standardization, Min-Max standardization, or the like.

The plurality of candidate nodes refer to basic spatial units and/or functional regions within a city. For example, the plurality of candidate nodes may be a street, a community, a residential region, a commercial region, an industrial region, a transportation hub region, an ecological leisure region, or the like. In some embodiments, the plurality of candidate nodes may be a plurality of nodes or locations preset by the emergency supervision management platform.

The heat island level refers to a quantitative index reflecting an intensity of a heat island effect. In some embodiments, the heat island level may be an intensity level of the heat island effect at a future moment or in a future time period. The future moment or the future time period may be set based on experience or may be set by the system. In some embodiments, the heat island level may be represented by a value within a range of 0 to 10.

In some embodiments, the emergency supervision management platform may determine the heat island levels of the plurality of candidate nodes through a prediction model. More descriptions regarding determining the heat island levels of the plurality of candidate nodes through the prediction model may be found in FIG. 3 and the related descriptions thereof.

In some embodiments, the emergency supervision management platform may determine the heat island levels based on heat island levels and heat island coefficients of a current moment or a current time period. For example, each of the heat island levels may be a product of the heat island level and the heat island coefficient of the current moment or the current time period.

In some embodiments, the heat island levels of the current moment or the current time period may include heat island intensities of air temperatures, heat island intensities of surface temperatures, and temperature levels of the plurality of candidate nodes. The emergency supervision management platform may determine the heat island levels of the plurality of candidate nodes based on a heat island intensity of an air temperature, a heat island intensity of a surface temperature, a temperature level, and a heat island coefficient of each of the plurality of candidate nodes. For example, for one of the plurality of candidate nodes, the heat island level of the candidate node may be characterized as: (the heat island intensity of the air temperature of the candidate node +the heat island intensity of the surface temperature of the candidate node +the temperature level of the candidate node) * the heat island coefficient.

The heat island intensity of the air temperature relates to a temperature difference between an urban air temperature and a suburban air temperature. For example, if the temperature difference between the urban air temperature and the suburban air temperature is less than or equal to 0 ° C., the heat island intensity of the air temperature is level 0. If the temperature difference between the urban air temperature and the suburban air temperature is greater than 0 ° C. and less than or equal to 2° C., the heat island intensity of the air temperature is level 1. If the temperature difference between the urban air temperature and the suburban air temperature is greater than 2° C. and less than or equal to 4° C., the heat island intensity of the air temperature is level 2. If the temperature difference between the urban air temperature and the suburban air temperature is greater than 4° C., the heat island intensity of the air temperature is level 3. In some embodiments, the emergency supervision management platform may obtain the heat island intensities of the air temperatures from the meteorological station data.

The heat island intensity of the surface temperature relates to a temperature difference between the urban surface temperature and the suburban surface temperature. A correspondence between the heat island intensity of the surface temperature and the temperature difference of the surface temperature is similar to a correspondence between the heat island intensity of the air temperature and the temperature difference of the air temperature. Specific content regarding the correspondence between the heat island intensity of the surface temperature and the temperature difference of the surface temperature may be found in the correspondence between the heat island intensity of the air temperature and the temperature difference of the air temperature. In some embodiments, the emergency supervision management platform may obtain the heat island intensities of the surface temperatures from the remote sensing data.

The temperature level refers to an intensity level corresponding to a temperature value of a node at the current moment or in the current time period. In some embodiments, the temperature level may be set based on experience or set by the system. For example, if the temperature value is less than 30° C., the temperature level is level 0. If the temperature value is greater than or equal to 30° C. and less than 35° C., the temperature level is level 1. If the temperature value is greater than or equal to 35° C. and less than 40° C., the temperature level is level 2. If the temperature value is greater than or equal to 40° C., the temperature level is level 3.

The heat island coefficient is used to characterize an influence degree of weather at a future moment or in a future time period on the heat island level. In some embodiments, the heat island coefficient may be represented by a value greater than 0.

In some embodiments, the emergency supervision management platform may determine the heat island coefficient based on the air temperature of the node at the future moment or in the future time period. Merely by way of example, the emergency supervision management platform may determine the heat island coefficient by looking up a preset table based on a temperature difference between the air temperature at the future moment or in the future time period and the air temperature at the current moment or in the current time period. The preset table includes a correspondence between the temperature difference of the air temperature and the heat island coefficient. For example, {index (the temperature difference of the air temperature is 3° C.)->query result (the heat island coefficient is 1.3)}. As another example, {index (the temperature difference of the air temperature is −3° C.)->query result (the heat island coefficient is 0.8)}. In some embodiments, the preset table may be constructed based on historical data or preset by the system.

The embodiments of the present disclosure determine the heat island level of each node or location by comprehensively considering the heat island intensity of the air temperature, the heat island intensity of the surface temperature, the temperature level, and the heat island coefficient, thereby effectively improving monitoring of the urban heat island effect. The comprehensive index can more comprehensively and multi-dimensionally evaluate the intensity and the impact of the urban heat island effect, thereby supporting scientific decision making, optimizing resource allocation, and improving the living environment.

In 220, determining one or more target nodes and cooling parameters of the one or more target nodes based on the heat island levels of the plurality of candidate nodes and a preset threshold.

Each cooling parameter includes a watering parameter of a watering vehicles and a spraying parameter of a spray system.

The one or more target nodes refer to one or more nodes among the plurality of candidate nodes that requires cooling. In some embodiments, the one or more target nodes may be nodes among the plurality of candidate nodes whose heat island levels are higher than the preset threshold. The preset threshold may be set based on experience or set by the system. For example, the preset threshold may be set to level 6.

The watering parameter refers to a parameter used to control water spraying of the one or more watering vehicles. In some embodiments, the watering parameter may include a watering mode (e.g., a side-flushing mode, a high-pressure water cannon mode, and a spray mode), a watering intensity (e.g., a water pressure, a flow rate, a spray distance, and a coverage volume), and a watering duration. The one or more watering vehicles may be automatic watering vehicles or watering vehicles requiring drivers.

The spray system refers to an automated system that achieves continuous or intermittent spray functions through a fixedly provided pipeline network and nozzle devices. In some embodiments, the spray system may be applied to the fields such as agriculture, landscaping, industry, and firefighting. For example, the spray system may be deployed in urban public regions such as parks and squares.

The spraying parameter refers to a parameter used to control spraying of the spray system. In some embodiments, the spraying parameter may include a spraying mode (e.g., a continuous spraying mode, an intermittent spraying mode, and a timed spraying mode), a spraying intensity (e.g., a water pressure, a flow rate, a coverage volume, and a spray pattern), and a spraying duration.

In some embodiments, two situations are known: a heat island level being less than or equal to the preset threshold, and a heat island level being greater than the preset threshold. In response to a determination that a heat island level of at least one candidate node of the plurality of candidate nodes is greater than the preset threshold, the emergency supervision management platform may determine the at least one candidate node as at least one target node. In some embodiments, the cooling parameters of the one or more target nodes may be positively correlated with the heat island levels of the one or more target nodes. For example, higher heat island levels of the one or more target nodes correspond to greater watering intensities and/or spraying intensities, and a longer watering duration and/or spraying duration. The watering mode may be set to the high-pressure water cannon mode. A pressure of the high-pressure water cannon mode may be between 10 Mpa to 20 Mpa. The spraying mode may be set to the continuous spraying mode.

In some embodiments, the emergency supervision management platform may send the cooling parameters of the one or more target nodes to the emergency supervision object platform via the emergency supervision sensor network platform to cool the one or more target nodes. For example, if the target node is an open square, the emergency supervision object platform may send received cooling parameters: {intermittent spraying mode; water pressure 4 Mpa; flow rate 10 L/min; coverage volume 200 m²; daily 10:00-18:00} to the spray system. The emergency supervision management platform may control the spray system to cool the open square based on the cooling parameters.

In 230, determining one or more watering vehicles corresponding to the one or more target nodes based on heat island levels of the one or more target nodes.

In some embodiments, if a count of the one or more target nodes is one, the emergency supervision management platform may determine the watering parameter of the target node based on the heat island level of the target node, and dispatch a watering vehicle matching the watering parameter to the target node based on the watering parameter of the target node. For example, the emergency supervision management platform may send the target node and the watering parameter of the target node to the emergency supervision object platform via the emergency supervision sensor network platform. The emergency supervision object platform may dispatch a watering vehicle capable of satisfying the watering parameter to the target node based on the received watering parameter. More descriptions regarding the watering parameter may be found in the operation 220 and the related descriptions thereof.

In some embodiments, the emergency supervision management platform is further configured to: for at least two of the one or more target nodes, determine priorities of the at least two target nodes based on heat island levels of the at least two target nodes; and obtain current locations of idle watering vehicles, and dispatch idle watering vehicles nearest to the at least two target nodes based on the priorities of the at least two target nodes.

The priority refers to a sequence in which the nodes are cooled. For example, a higher priority corresponds to a more forward cooling sequence of a node.

In some embodiments, the priorities of the one or more target nodes may be positively correlated with the heat island levels of the one or more target nodes. For example, higher heat island levels of the one or more target node correspond to higher priorities.

The idle watering vehicle refers to a watering vehicle that is not performing a watering task and is in a standby or non-working state. The current location of the idle watering vehicle refers to current geographic coordinates or a current location of the idle watering vehicle. In some embodiments, the emergency supervision management platform may obtain the current locations of the idle watering vehicles via a global positioning system (GPS), an IoT device, a geographic information system (GIS), and the emergency supervision object platform. In some embodiments, the current locations of the idle watering vehicles may include latitude and longitude, address information, a parking lot number, or the like.

In some embodiments, the emergency supervision management platform may send the one or more target nodes to the emergency supervision object platform in sequence via the emergency supervision sensor network platform based on the priorities of the one or more target nodes. The emergency supervision object platform may dispatch the idle watering vehicles nearest to the one or more target nodes to the one or more target nodes based on the received target nodes and the current locations of the idle watering vehicles.

The embodiments of the present disclosure can ensure that limited water resources and vehicle resources are prioritized for regions most in need of cooling by evaluating the severity of the heat island effect of each node based on the heat island level and prioritizing dispatch of watering vehicles to high-temperature regions, thereby avoiding resource waste and improving cooling efficiency.

In 240, sending the one or more target nodes to navigation terminals of the one or more watering vehicles corresponding to the one or more target nodes via a wireless network to control the navigation terminals to display navigation routes to the one or more target nodes.

The navigation terminals refer to dedicated devices or systems provided on the watering vehicles and configured to implement real-time positioning, route navigation, task reception and execution, condition monitoring, or the like of the watering vehicles. In some embodiments, the navigation terminals may include a vehicle-mounted navigation terminal, a mobile terminal equipped with navigation software (e.g., a mobile phone and a personal digital assistant), or the like.

In some embodiments, the emergency supervision management platform may send the one or more target nodes and the navigation routes to the one or more target nodes to the emergency supervision object platform via the emergency supervision sensor network platform and/or the wireless network. The emergency supervision object platform may send the received target nodes and the navigation routes to the target nodes to the navigation terminals of the one or more watering vehicles.

In 250, controlling the one or more watering vehicles corresponding to the one or more target nodes and spray systems to perform watering and spraying based on the cooling parameters of the one or more target nodes.

In some embodiments, the emergency supervision management platform may send the one or more target nodes and the cooling parameters of the one or more target nodes to the emergency supervision object platform via the emergency supervision sensor network platform. The emergency supervision object platform may generate a first control signal corresponding to the watering parameter and a second control signal corresponding to the spraying parameter respectively based on the received target nodes and the cooling parameters (i.e., the watering parameter and the spraying parameter) of the target nodes, and control the one or more watering vehicles and the spray system to perform water spraying and spraying respectively via the first control signal and the second control signal. More descriptions regarding the watering parameter and the spraying parameter may be found in the operation 220 and the related descriptions thereof.

In some embodiments, each of the one or more watering vehicles includes an on-board sensor. The emergency supervision management platform may obtain a surface temperature, an air humidity, and a wind speed at a current location of each of the one or more watering vehicles through the on-board sensor; and adjust a watering mode, a watering intensity and a duration of each of the one or more watering vehicles based on the surface temperature, the air humidity and the wind speed at the current location. More descriptions regarding the current location may be found in the operation 230 and the related descriptions thereof.

The on-board sensors of the one or more watering vehicles refer to various sensing devices provided at key positions (e.g., a water tank, a watering system, a chassis, a cockpit, or the like) of the one or more watering vehicles. In some embodiments, the on-board sensors of the one or more watering vehicles may include a high-precision surface temperature sensor, an air temperature sensor, an air humidity sensor, and a wind speed sensor.

In some embodiments, the emergency supervision management platform may obtain an updated watering mode, an updated watering intensity, and an updated duration of the one or more watering vehicles through a vector database based on a surface temperature, an air humidity, and a wind speed of a current node. For example, the emergency supervision management platform may construct a feature vector based on the surface temperature, the air humidity, and the wind speed of the current node, and retrieve in the vector database based on the feature vector to obtain the updated watering mode, the updated watering intensity, and the updated duration of the one or more watering vehicles. The vector database refers to a database for storing, indexing, and querying vectors. Similarity queries and other vector management operations can be performed on a large number of vectors through the vector database. The vector database may be stored in the database.

In some embodiments, the emergency supervision management platform may obtain reference surface temperature data (e.g., a sequence of surface temperatures at a plurality of historical time moments or historical time periods), reference air humidity data (e.g., a sequence of air humidity values at a plurality of historical time moments or historical time periods), and reference wind speed data (e.g., a sequence of wind speeds at a plurality of historical time moments or historical time periods) based on historical data of reference nodes, and construct a plurality of reference vectors based on the reference surface temperature data, the reference air humidity data, and the reference wind speed data. Each of the plurality of reference vectors has a corresponding vector label. The vector label may include a reference watering mode, a reference watering intensity, and a reference duration that correspond to a fastest cooling speed. The emergency supervision management platform may store the plurality of reference vectors and the corresponding vector labels to the vector database.

In some embodiments, the computing unit of the emergency supervision management platform may calculate a similarity (e.g., a cosine similarity and a Euclidean distance) between the feature vector and each of the reference vectors, and determine a vector label of a reference vector with a highest similarity as the updated watering mode, the updated watering intensity, and the updated duration of the one or more watering vehicles. More descriptions regarding the watering mode and the watering intensity may be found in the operation 220 and the related descriptions thereof.

In the embodiments of the present disclosure, during the watering operation, the on-board sensor transmits the surface temperature, the air humidity, and the wind speed back to the emergency supervision management platform in real time. The emergency supervision management platform intelligently adjusts or updates the watering mode, the watering intensity, and the duration of the one or more watering vehicles based on the surface temperature, the air humidity, and the wind speed of the current node, thereby achieving real-time adaptive adjustment of a watering strategy and improving cooling efficiency.

The embodiments of the present disclosure determine the heat island levels of the plurality of candidate nodes or candidate locations based on the remote sensing data, the meteorological station data, the environmental data, and the urban activity data, automatically plan and dispatch the one or more watering vehicles to perform the precise cooling operation, and remotely start and adjust the spray system in public regions such as parks and squares to rapidly reduce the local temperature through water evaporation. Meanwhile, the embodiments of the present disclosure can automatically advance or increase the irrigation amount for green spaces through the spray system, maximize the transpiration cooling effect of plants, increase the water circulation, and enhance the evaporative cooling capacity, thereby achieving automated water mist or water spraying for cooling.

It should be noted that the above description of the process 200 is merely for example and illustration, and does not limit the scope of application of the present disclosure. Those skilled in the art may make various modifications and changes to the process 200 under the guidance of the present disclosure. However, these modifications and changes are still within the scope of the present disclosure.

FIG. 3 is a schematic diagram illustrating a structure of a prediction model according to some embodiments of the present disclosure.

In some embodiments, the emergency supervision management platform may determine heat island levels of a plurality of candidate nodes through a prediction model 310. The prediction model 310 is a machine learning model. For example, the machine learning model may include a neural network (NN) model, a convolutional neural network (CNN) model, a recurrent neural network (RNN) model, a graph neural network (GNN) model, or the like.

In some embodiments, the prediction model 310 may be a machine learning model with a custom structure including a plurality of layers. As shown in FIG. 3, the prediction model 310 may include a heat effect processing layer 311 and a heat island prediction layer 312. In some embodiments, the heat effect processing layer 311 may be the NN model, and the heat island prediction layer 312 may be the GNN model.

In some embodiments, an input of the heat effect processing layer 311 may include remote sensing data 311-1, meteorological station data 311-2, environmental data 311-3, and urban activity data 311-4 of a candidate node among the plurality of candidate nodes. An output of the heat effect processing layer 311 may include a heat effect latent vector 311-5 of the candidate node.

The heat effect latent vector refers to a feature vector for determining the heat island level. For example, elements of the heat effect latent vector may include a surface temperature, a vegetation coverage rate, an air temperature, a wind direction, a wind speed, a traffic flow, or the like. In some embodiments, the heat effect latent vector may be normalized or standardized remote sensing data, meteorological station data, environmental data, and urban activity data. More descriptions regarding the remote sensing data 311-1, the meteorological station data 311-2, the environmental data 311-3, and the urban activity data 311-4 may be found in FIG. 2 and the related descriptions thereof.

In some embodiments, an input of the heat island prediction layer 312 may include an urban heat effect map 320 and the heat effect latent vector 311-5. An output of the heat island prediction layer 312 may include heat island levels 330 of the plurality of candidate nodes. More descriptions regarding the heat island levels 330 of the plurality of candidate nodes may be found in FIG. 2 and the related descriptions thereof.

The urban heat effect map 320 refers to a network model of an urban heat effect distribution constructed based on nodes and edges in graph theory, which visually presents heat effect differences, heat flow transfer paths, and spatial correlation relationships between different regions of a city.

In some embodiments, nodes 320-1 of the urban heat effect map 320 may be the plurality of candidate nodes. Edges 320-2 exist between nodes 320-1 that satisfy a preset location condition. Node attributes may include the heat effect latent vector 311-5 of the one of the plurality of candidate nodes output by the heat effect processing layer 311, a reference watering parameter of one of the plurality of candidate node, and a reference spraying parameter of one of the plurality of candidate node. Edge attributes may include a feature of a segmentation zone corresponding to the edge and a cooling factor.

The preset location condition refers to a preset condition for existence of an edge connecting two nodes. In some embodiments, the preset location condition refers to that a segmentation zone exists between two nodes and a distance between the two nodes is less than a preset distance threshold.

In some embodiments, the reference watering parameter and the reference spraying parameter may be determined based on historical data of the plurality of candidate nodes. The reference watering parameter and the reference spraying parameter are similar to the watering parameter and the spraying parameter. More descriptions may be found in FIG. 2 and the related descriptions thereof.

The segmentation zone refers to a transitional or boundary region used to separate the plurality of candidate nodes in geographical space or functional layout. For example, the segmentation zone may include a road, a green isolation belt, or the like. The feature of the segmentation zone refers to a feature of the segmentation zone in terms of physical form, ecological function, or the like. For example, the feature of the segmentation zone may include a road width, a shape (e.g., a strip shape and a planar shape) of a green isolation belt, a vegetation type, a vegetation coverage rate, or the like. In some embodiments, the feature of the segmentation zone may be set based on experience or preset by the system.

The cooling factor is used to characterize an influence degree of the one or more watering vehicles and the spray system on a cooling effect. In some embodiments, the cooling factor may be determined based on the reference watering parameter, the reference spraying parameter, a distance between nodes, a wind direction, and a wind speed. For example, the emergency supervision management platform may determine a water mist density ρ of each of the nodes 320-1 based on the reference watering parameter and the reference spraying parameter. The water mist density ρ may characterize a mass of water mist particles per unit volume of a coverage range. A larger water mist density ρ means a higher mass of water mist particles per unit volume. The larger the number of water mist particles, the faster the evaporation and diffusion rate, the higher the heat absorption efficiency, and the better the cooling effect.

For example, taking the use of the one or more watering vehicles for cooling as an example, the water mist density ρ may be characterized as: ρ=(reference flow rate*reference watering duration*density of water)/reference coverage volume. The emergency supervision management platform may perform standardization or normalization on the water mist density ρ, the distance between the nodes, the wind direction, and the wind speed through Z-score standardization, Min-Max standardization, or the like, and determine the cooling factor based on the normalized or standardized water mist density ρ, the normalized or standardized distance between the nodes, the normalized or standardized wind direction, and the normalized or standardized wind speed through a Gaussian plume model or computational fluid dynamics (CFD). The cooling factor may be a value between 0 and 1. A higher value indicates a better cooling effect.

In some embodiments, the wind direction and/or a water mist diffusion direction is a direction of the edges 320-2. One node may have an outgoing edge and/or an incoming edge. The incoming edge refers to an edge pointing to the node. The outgoing edge refers to an edge starting from the node and pointing to another node.

In some embodiments, in response to the one or more watering vehicles moving based on the edges 320-2 and/or the spray system being deployed based on the edges 320-2 and performing a watering and/or spraying operation, the emergency supervision management platform may determine the cooling factor based on the reference watering parameter (e.g., the reference watering intensity and the reference watering duration) of the one or more watering vehicles, the reference spraying parameter (e.g., the reference spraying intensity and the reference spraying duration) of the spray system, and a distance d between the nodes 320-1. For example, the cooling factor may be positively correlated with the reference watering intensity, the reference spraying intensity, the reference watering duration, and the reference spraying duration, and negatively correlated with the distance d. For example, a higher reference watering intensity and a higher reference spraying intensity, and a larger reference watering duration and a larger reference spraying duration correspond to a higher cooling factor. A larger distance d corresponds to a smaller cooling factor.

The embodiments of the present disclosure adopt a graph-structured urban heat effect map and embed the prediction model, which not only enhances visualization and quantitative analysis capabilities for heat effect distribution, but also clarifies heat transmission paths and key impact regions of the heat effect, thereby improving accuracy in determining the heat effect levels at different locations.

In some embodiments, the emergency supervision management platform may determine the prediction model 310 through joint training based on the heat effect processing layer 311 and the heat island prediction layer 312. Training samples may be constructed based on historical data. The historical data may be obtained from the database. The training samples may include at least one set of sample remote sensing data, sample meteorological station data, sample environmental data, sample urban activity data of sample nodes at a first historical time moment or in a first historical time period, and a sample urban heat effect map constructed based on the sample nodes. Labels may be actual heat island levels of the sample nodes at a second historical time moment or in a second historical time period. The second historical time moment or the second historical time period is after the first historical time moment or the first historical time period. In some embodiments, the labels may be determined and annotated based on the historical data of the sample nodes.

During training, the sample remote sensing data, the sample meteorological station data, the sample environmental data, and the sample urban activity data are input into the heat effect processing layer 311 to obtain a heat effect latent vector output by the heat effect processing layer 311. The heat effect latent vector is used as training data, the heat effect latent vector and the sample urban heat effect map are input into the heat island prediction layer 312 to obtain a heat island level output by the heat island prediction layer 312. A loss function is constructed based on the labels and the heat island level output by the heat island prediction layer 312. Parameters of the heat effect processing layer 311 and the heat island prediction layer 312 are synchronously iteratively updated (e.g., by gradient descent) based on the loss function until a preset training condition is met, then the training ends and a trained prediction model 310 is obtained. The preset training condition may include, but is not limited to, convergence of the loss function, a training period reaching a threshold, or the like.

More descriptions regarding the remote sensing data, the meteorological station data, the environmental data, the urban activity data, and the heat island level may be found in FIG. 2 and the related descriptions thereof.

The embodiments of the present disclosure obtain the prediction model through joint training of the heat effect processing layer and the heat island prediction layer, which not only improves prediction accuracy and spatial resolution capability of the prediction model, but also enhances dynamic adaptability and resource optimization efficiency of the prediction model.

The embodiments of the present disclosure determine the heat island levels of the plurality of candidate nodes or locations based on the urban heat effect map using the trained prediction model, which can combine actual situations to more accurately estimate key regions affected by the heat island effect, thereby reducing manpower costs and resource waste required for manual assessment.

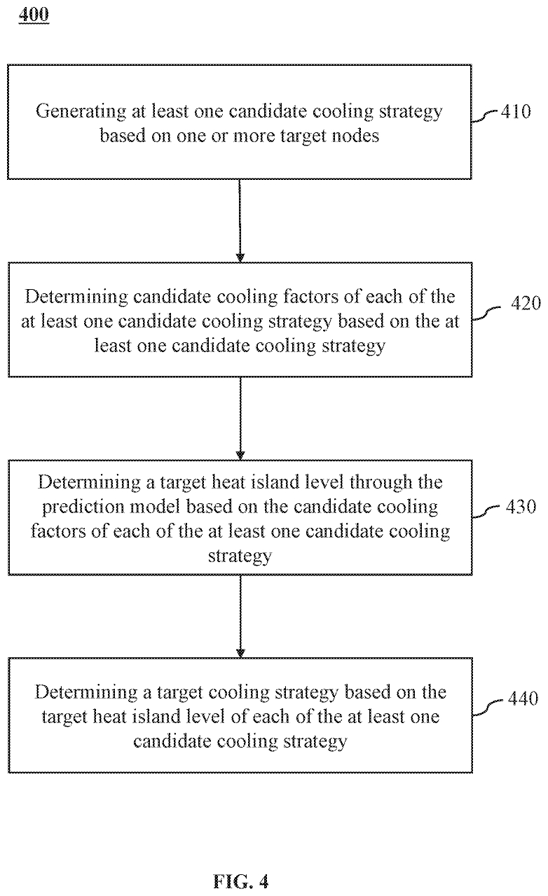

FIG. 4 is a flowchart illustrating an exemplary process of determining a target cooling strategy according to some embodiments of the present disclosure. As shown in FIG. 4, a process 400 includes the following operations. In some embodiments, the process 400 may be performed by the emergency supervision management platform 120.

In 410, generating at least one candidate cooling strategy based on one or more target nodes.

The at least one candidate cooling strategy refers to a cooling solution or measure to be selected that is proposed for the urban heat island effect. In some embodiments, each of the at least one candidate cooling strategy may include candidate cooling parameters and one or more watering vehicles corresponding to the one or more target nodes. The candidate cooling parameters are similar to the cooling parameters. More descriptions regarding the cooling parameters and the one or more target nodes may be found in FIG. 2 and the related descriptions thereof.

In some embodiments, the emergency supervision management platform may generate a plurality of initial cooling strategies based on current locations of the one or more watering vehicles and one of the one or more target nodes; for one of the plurality of initial cooling strategies, determine a load balancing score of the initial cooling strategy based on workloads of the one or more watering vehicles; and determine the at least one candidate cooling strategy based on load balancing scores of the plurality of initial cooling strategies.

More descriptions regarding the current locations of the one or more watering vehicles may be found in FIG. 2 and the related descriptions thereof.

The initial cooling strategies refer to strategies used to determine the at least one candidate cooling strategy. For example, the emergency supervision management platform may select the at least one candidate cooling strategy from the initial cooling strategies based on the load balancing scores of the plurality of initial cooling strategies. Content included in the initial cooling strategies is similar to content included in the at least one candidate cooling strategy. More descriptions may be found in the at least one candidate cooling strategy and the related descriptions thereof.

In some embodiments, the emergency supervision management platform may generate the plurality of initial cooling strategies based on the current locations of the one or more watering vehicles and one of the one or more target nodes through at least one of nearest distance, random allocation, or random exchange.

In some embodiments, in response to the nearest distance, the emergency supervision management platform may assign a nearest watering vehicle to each of a plurality of target nodes respectively based on priorities of the plurality of target nodes and the current locations of a plurality of watering vehicles. The emergency supervision management platform may determine a system default initial cooling parameter and assigned watering vehicles corresponding to the one or more target nodes as the plurality of initial cooling strategies. More descriptions regarding the priorities of the one or more target nodes and the current locations of the one or more watering vehicles may be found in FIG. 2 and the related descriptions thereof.

In some embodiments, in response to the random allocation, the emergency supervision management platform may randomly sort the plurality of target nodes and randomly generate an initial cooling parameter, randomly assign the one or more watering vehicles based on the sorting of the plurality of target nodes, and determine the randomly generated initial cooling parameter and the assigned watering vehicles corresponding to the plurality of target nodes as the plurality of initial cooling strategies.

In some embodiments, in response to the random exchange, the emergency supervision management platform may generate a plurality of initial cooling strategies under exchange through one of the nearest distance or the random allocation, randomly select at least two initial cooling strategies under exchange from the plurality of initial cooling strategies under exchange, and randomly exchange initial cooling parameters in the at least two initial cooling strategies under exchange to generate at least two initial cooling strategies. The initial cooling parameters are similar to the cooling parameters. More descriptions may be found in FIG. 2 and the related descriptions thereof.

The embodiments of the present disclosure generate the plurality of initial cooling strategies based on the current locations of the one or more watering vehicles and the one or more target nodes through at least one of the nearest distance, the random allocation, or the random exchange, which can ensure diversity of the cooling strategies for the urban heat island effect and improve the cooling effect.

The workload of the watering vehicle refers to a working duration of the watering vehicle. In some embodiments, the workload of the watering vehicle may include a driving duration without performing a watering operation and a watering duration. For example, the workload of the watering vehicle may be a weighted sum of the driving duration without performing the watering operation and the watering duration.

The load balancing score is used to evaluate balance of the workloads of the one or more watering vehicles performing watering operations at corresponding target nodes according to the initial cooling parameters (e.g., the initial watering parameter) in the initial cooling strategies. In some embodiments, the load balancing score may be determined based on the workloads of the plurality of watering vehicles. The load balancing score may be represented by a value between 0 and 100. The initial cooling parameters (e.g., the initial watering parameter) are similar to the cooling parameters (e.g., the watering parameter). More descriptions may be found in FIG. 2 and the related descriptions thereof.

In some embodiments, for one initial cooling strategy of the plurality of initial cooling strategies, the load balancing score of the initial cooling strategy may be negatively correlated with a standard deviation or a variance of workloads of the plurality of watering vehicles performing watering operations based on the initial cooling strategy. For example, the smaller the standard deviation or the variance of the workloads of the plurality of watering vehicles, the higher the load balancing score of the initial cooling strategy.

In some embodiments, the emergency supervision management platform may sort the plurality of initial cooling strategies in a descending order based on the load balancing scores of the plurality of initial cooling strategies, and determine top N initial cooling strategies as the at least one candidate cooling strategy. N is a positive integer greater than or equal to 1. A value of N may be set based on experience or may be set by the system. In some embodiments, the emergency supervision management platform may determine initial cooling strategies of which the load balancing scores are higher than a preset score threshold as the at least one candidate cooling strategy from the plurality of initial cooling strategies based on the load balancing scores of the plurality of initial cooling strategies. The preset score threshold may be set based on experience or may be set by the system. For example, the preset score threshold may be set to 60.

In the embodiments of the present disclosure, when allocating watering tasks to the one or more watering vehicles, the embodiments of the present disclosure consider not only distances between the one or more watering vehicles and the one or more target nodes and the priorities of the one or more target nodes, but also the workloads of the one or more watering vehicles, thereby achieving the goal of preferentially allocating the watering vehicles that are close to the target nodes and have a light load to the target nodes, and avoiding the situation where the workloads of the watering vehicle are overloaded.

In 420: determining candidate cooling factors of each of the at least one candidate cooling strategy based on the at least one candidate cooling strategy.

The candidate cooling factor is used to characterize an influence degree of the candidate cooling strategy on the cooling effect. In some embodiments, the candidate cooling factor is similar to the cooling factor. More descriptions may be found in FIG. 3 and the related descriptions thereof.

In some embodiments, the emergency supervision management platform may determine the candidate cooling factors of each of the at least one candidate cooling strategy based on the candidate cooling parameters in the at least one candidate cooling strategy. For example, the emergency supervision management platform may determine the candidate cooling factors based on candidate watering parameters (e.g., a watering intensity and a watering duration) in the candidate cooling parameters and/or candidate spraying parameters (e.g., a spraying intensity and a spraying duration) in the candidate cooling parameters. The candidate cooling parameters are similar to the cooling parameters. More descriptions may be found in FIG. 2 and the related descriptions thereof. A process of determining the candidate cooling factors based on the candidate cooling parameters is similar to a process of determining the cooling factor based on the cooling parameters. More descriptions may be found in FIG. 3 and the related descriptions thereof.

In 430, determining a target heat island level through a prediction model based on the candidate cooling factors of each of the at least one candidate cooling strategy.

The target heat island level refers to a heat island level of the one or more target nodes after the at least one candidate cooling strategy is performed on the one or more target nodes. In some embodiments, the target heat island level is similar to the heat island level. More descriptions may be found in FIG. 2 and the related descriptions thereof.

In some embodiments, the emergency supervision management platform may determine an edge pointing to one of the one or more target nodes based on an urban heat effect map, update the cooling factor in edge attributes of the edge to the candidate cooling factor of the at least one candidate cooling strategy, and output the target heat island level corresponding to the at least one candidate cooling strategy through the prediction model based on updated edge attributes of the urban heat effect map. More descriptions regarding the urban heat effect map and the prediction model may be found in FIG. 3 and the related descriptions thereof.

In 440, determining a target cooling strategy based on the target heat island level of each of the at least one candidate cooling strategy.

The target cooling strategy refers to a cooling strategy selected from the at least one candidate cooling strategy and applied to the one or more target nodes. In some embodiments, the target cooling strategy is similar to the at least one candidate cooling strategy. More descriptions may be found in the operation 410 and the related descriptions thereof.

In some embodiments, the emergency supervision management platform may determine a candidate cooling strategy of which a target heat island level is less than or equal to a preset threshold as the target cooling strategy. More descriptions regarding the preset threshold may be found in FIG. 2 and the related descriptions thereof. In some embodiments, the emergency supervision management platform may sort the target heat island level of the at least one candidate cooling strategy based on the target heat island level of the at least one candidate cooling strategy, and determine a candidate cooling strategy with a lowest target heat island level as the target cooling strategy.

The embodiments of the present disclosure predict cooling effects of a plurality of candidate cooling strategies by predicting the target heat island levels of the plurality of candidate cooling strategies, to select the target cooling strategy with an optimal cooling effect, thereby effectively improving the cooling effect and the cooling efficiency for the urban heat island effect.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended for those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the count of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teachings of the present disclosure. Accordingly, the embodiments of the present disclosure are not limited to the embodiments introduced and described in the present disclosure explicitly.

What is claimed is:

1. A system for urban heat island effect emergency monitoring based on an Internet of Things (IoT) large model, comprising an emergency supervision management platform, wherein the emergency supervision management platform is configured to:
determine heat island levels of a plurality of candidate nodes based on remote sensing data, meteorological station data, environmental data, and urban activity data;
determine one or more target nodes and cooling parameters of the one or more target nodes based on the heat island levels of the plurality of candidate nodes and a preset threshold, wherein each cooling parameter includes a watering parameter of a watering vehicle and a spraying parameter of a spray system;
determine one or more watering vehicles corresponding to the one or more target nodes based on heat island levels of the one or more target nodes;
send the one or more target nodes to navigation terminals of the one or more watering vehicles corresponding to the one or more target nodes via a wireless network to control the navigation terminals to display navigation routes to the one or more target nodes; and
control the one or more watering vehicles corresponding to the one or more target nodes and spray systems to perform watering and spraying based on the cooling parameters of the one or more target nodes.

2. The system according to claim 1, wherein the emergency supervision management platform is further configured to:
determine the heat island levels of the plurality of candidate nodes through a prediction model, wherein the prediction model is a machine learning model, and the prediction model includes a heat effect processing layer and a heat island prediction layer.

3. The system according to claim 2, wherein an input of the heat island prediction layer includes an urban heat effect map, nodes of the urban heat effect map are the plurality of candidate nodes, edges exist between nodes that satisfy a preset location condition, node attributes include a heat effect latent vector output by the heat effect processing layer, and edge attributes include a cooling factor.

4. The system according to claim 2, wherein the emergency supervision management platform is further configured to:
generate at least one candidate cooling strategy based on the one or more target nodes, wherein each of the at least one candidate cooling strategy includes candidate cooling parameters and the one or more watering vehicles corresponding to the one or more target nodes;
determine candidate cooling factors of each of the at least one candidate cooling strategy based on the at least one candidate cooling strategy;
determine a target heat island level through the prediction model based on the candidate cooling factors of each of the at least one candidate cooling strategy; and
determine a target cooling strategy based on the target heat island level of each of the at least one candidate cooling strategy.

5. The system according to claim 4, wherein the emergency supervision management platform is further configured to:
generate a plurality of initial cooling strategies based on current locations of the one or more watering vehicles and one of the one or more target nodes;
for one of the plurality of initial cooling strategies,
determine a load balancing score of the initial cooling strategy based on workloads of the one or more watering vehicles; and
determine the at least one candidate cooling strategy based on load balancing scores of the plurality of initial cooling strategies.

6. The system according to claim 5, wherein the emergency supervision management platform is further configured to:
generate the plurality of initial cooling strategies based on the current locations of the one or more watering vehicles and one of the one or more target nodes through at least one of nearest distance, random allocation, or random exchange.

7. The system according to claim 1, wherein each of the one or more watering vehicles includes an on-board sensor, and the emergency supervision management platform is further configured to:
obtain a surface temperature, an air humidity, and a wind speed at a current location of each of the one or more watering vehicles through the on-board sensor; and
adjust a watering mode, a watering intensity, and a duration of each of the one or more watering vehicles based on the surface temperature, the air humidity, and the wind speed at the current location.

8. The system according to claim 1, wherein the emergency supervision management platform is further configured to:
for at least two of the one or more target nodes,
determine priorities of the at least two target nodes based on heat island levels of the at least two target nodes; and
obtain current locations of idle watering vehicles, and dispatch idle watering vehicles nearest to the at least two target nodes based on the priorities of the at least two target nodes.

9. The system according to claim 1, wherein the emergency supervision management platform is further configured to:
determine the heat island levels of the plurality of candidate nodes based on a heat island intensity of an air temperature, a heat island intensity of a surface temperature, a temperature level, and a heat island coefficient of each of the plurality of candidate nodes.

10. The system according to claim 2, wherein the emergency supervision management platform is further configured to:
determine the prediction model through joint training based on the heat effect processing layer and the heat island prediction layer.

11. A method for urban heat island effect emergency monitoring based on an Internet of Things (IoT) large model, comprising:
determining heat island levels of a plurality of candidate nodes based on remote sensing data, meteorological station data, environmental data, and urban activity data;
determining one or more target nodes and cooling parameters of the one or more target nodes based on the heat island levels of the plurality of candidate nodes and a preset threshold, wherein each cooling parameter includes a watering parameter of a watering vehicle and a spraying parameter of a spray system;
determining one or more watering vehicles corresponding to the one or more target nodes based on heat island levels of the one or more target nodes;
sending the one or more target nodes to navigation terminals of the one or more watering vehicles corresponding to the one or more target nodes via a wireless network to control the navigation terminals to display navigation routes to the one or more target nodes; and
controlling the one or more watering vehicles corresponding to the one or more target nodes and spray systems to perform watering and spraying based on the cooling parameters of the one or more target nodes.

12. The method according to claim 11, wherein the determining heat island levels of a plurality of candidate nodes includes:
determining the heat island levels of the plurality of candidate nodes through a prediction model, wherein the prediction model is a machine learning model, and the prediction model includes a heat effect processing layer and a heat island prediction layer.

13. The method according to claim 12, wherein an input of the heat island prediction layer includes an urban heat effect map, nodes of the urban heat effect map are the plurality of candidate nodes, edges exist between nodes that satisfy a preset location condition, node attributes include a heat effect latent vector output by the heat effect processing layer, and edge attributes include a cooling factor.

14. The method according to claim 12, further comprising:
generating at least one candidate cooling strategy based on the one or more target nodes, wherein each of the at least one candidate cooling strategy includes candidate cooling parameters and the one or more watering vehicles corresponding to the one or more target nodes;
determining candidate cooling factors of each of the at least one candidate cooling strategy based on the at least one candidate cooling strategy;
determining a target heat island level through the prediction model based on the candidate cooling factors of each of the at least one candidate cooling strategy; and
determining a target cooling strategy based on the target heat island level of each of the at least one candidate cooling strategy.

15. The method according to claim 14, wherein the generating at least one candidate cooling strategy based on the one or more target nodes includes:
generating a plurality of initial cooling strategies based on current locations of the one or more watering vehicles and one of the one or more target nodes;
for one of the plurality of initial cooling strategies,
determining a load balancing score of the initial cooling strategy based on workloads of the one or more watering vehicles; and
determining the at least one candidate cooling strategy based on load balancing scores of the plurality of initial cooling strategies.

16. The method according to claim 15, wherein the generating a plurality of initial cooling strategies based on current locations of the one or more watering vehicles and the one or more target nodes includes:
generating the plurality of initial cooling strategies based on the current locations of the one or more watering vehicles and one of the one or more target nodes through at least one of nearest distance, random allocation, or random exchange.

17. The method according to claim 11, wherein each of the one or more watering vehicles includes an on-board sensor, and the method further comprises:
obtaining a surface temperature, an air humidity, and a wind speed at a current location of each of the one or more watering vehicles through the on-board sensor; and;
adjusting a watering mode, a watering intensity, and a duration of each of the one or more watering vehicles based on the surface temperature, the air humidity, and the wind speed at the current location.

18. The method according to claim 11, further comprising:
for at least two of the one or more target nodes,
determining priorities of the at least two target nodes based on heat island levels of the at least two target nodes; and
obtaining current locations of idle watering vehicles, and dispatching idle watering vehicles nearest to the at least two target nodes based on the priorities of the at least two target nodes.

19. The method according to claim 11, wherein the determining heat island levels of a plurality of candidate nodes includes:
determining the heat island levels of the plurality of candidate nodes based on a heat island intensity of an air temperature, a heat island intensity of a surface temperature, a temperature level, and a heat island coefficient of each of the plurality of candidate nodes.

20. A non-transitory computer-readable storage medium, comprising computer instructions that, when read by a computer, direct the computer to executes a method for urban heat island effect emergency monitoring based on an Internet of Things (IoT) large model, comprising:
determining heat island levels of one or more candidate nodes based on remote sensing data, meteorological station data, environmental data, and urban activity data;
determining one or more target nodes and cooling parameters of the one or more target nodes based on the heat island levels of the plurality of candidate nodes and a preset threshold, wherein each cooling parameter includes a watering parameter of a watering vehicle and a spraying parameter of a spray system;
determining one or more watering vehicles corresponding to the one or more target nodes based on heat island levels of the one or more target nodes;
sending the one or more target nodes to navigation terminals of the one or more watering vehicles corresponding to the one or more target nodes via a wireless network to control the navigation terminals to display navigation routes to the one or more target nodes; and
controlling the one or more watering vehicles corresponding to the one or more target nodes and spray systems to perform watering and spraying based on the cooling parameters of the one or more target nodes.
